(19) United States
(12) Patent Application Publication
(10) Pub. No.: US 2013/0257380 A1
(43) Pub. Date: Oct. 3, 2013

(54) SEMICONDUCTOR DEVICE FOR BATTERY CONTROL AND BATTERY PACK

(71) Applicant: RENESAS ELECTRONICS CORPORATION, Kawasaki-shi (JP)

(72) Inventors: Daisuke Kato, Kanagawa (JP); Ryosei Makino, Kanagawa (JP); Ryosuke Enomoto, Kanagawa (JP)

(73) Assignee: RENESAS ELECTRONICS CORPORATION, Kawasaki-shi (JP)

(21) Appl. No.: 13/783,241

(22) Filed: Mar. 2, 2013

(30) Foreign Application Priority Data
Mar. 30, 2012 (JP) 2012-079689

(51) Int. Cl. H02J 7/00

(52) U.S. Cl. CPC H02J 7/0075
USPC 320/131

(57) ABSTRACT

A semiconductor device for battery control is provided with a control circuit capable of controlling turning on/off of a charging transistor provided in a charging path of a battery, a CPU capable of controlling charging of the battery via the control circuit, and a deep discharge detection circuit capable of detecting a deeply discharged state of the battery. The semiconductor device is also provided with a switch circuit which, when a deeply discharged state of the battery is detected by the deep discharge detection circuit, preferentially sends the detection result to the control circuit and, thereby, forcibly turns off the charging transistor regardless of charging control by the CPU. When a deeply discharged state of the battery is detected, the charging path of the battery is shut off to prohibit subsequent charging regardless of charging control by the CPU.

### CROSS-REFERENCE TO RELATED APPLICATIONS

The disclosure of Japanese Patent Application No. 2012-079689 filed on Mar. 30, 2012 including the specification, drawings and abstract is incorporated herein by reference in its entirety.

### BACKGROUND

The present invention relates to a semiconductor device for battery control and a battery pack, and more particularly, to those suitably applicable to charge control systems for lithium-ion secondary batteries.

Lithium-ion secondary batteries are a type of non-aqueous electrolyte secondary batteries in which lithium ions in electrolyte effect electric conduction. In a lithium-ion secondary battery, when the battery voltage lowers to a voltage (in a deeply discharged region) lower than a minimum operable voltage, internal short-circuiting may be caused by metallic lithium deposition. In such a state, charging the secondary battery may cause the secondary battery to ignite or rupture. Therefore, for safety enhancement, it is necessary to prohibit charging a secondary battery in a deeply discharged state.

In Japanese Unexamined Patent Publication No. 2011-115012, a battery pack and a control method thereof are disclosed in which, when the voltage of a lithium-ion secondary battery drops to or below a threshold representing a recharge-prohibited voltage, the battery voltage is determined to have dropped into a deep discharge region and recharging of the battery pack is prohibited.

In Japanese Unexamined Patent Publication No. 2010-50045, a battery charger is disclosed which determines a secondary battery having been repeatedly over-discharged to be an over-discharged battery and avoids charging the secondary battery so as to prevent failure which may result from charging the secondary battery.

In Japanese Unexamined Patent Publication No. 2003-168490, a deep discharge detection technique is disclosed. The technique makes use of a change in information stored in a volatile memory caused when the battery voltage used to drive the volatile memory drops to a very low level (a deeply discharged state) lower than required to ensure operation of the volatile memory. The change in stored information is detected by an external device coupled to the battery pack. When coupled to the battery, the external device detects a deeply discharged state of the battery and writes the number of times the battery has been deeply discharged in a non-volatile memory. When the number reaches a predetermined number, processing to prohibit charging/discharging of the battery is performed.

### SUMMARY

According to the technique disclosed in Japanese Unexamined Patent Publication No. 2011-115012, when the battery voltage drops to or below a threshold V3 representing a recharge-prohibited voltage, the battery voltage is determined to have dropped into a deep discharge region and recharging of the battery pack is prohibited. However, the configuration of the control unit to perform such control is not concretely described. It can be assumed that the control unit is comprised of a CPU (Central Processing Unit) to execute a predetermined firmware. If so, the function for protecting the battery cannot be used when the CPU goes out of control.

According to the technique disclosed in Japanese Unexamined Patent Publication No. 2010-50045, the function to protect a secondary battery is provided in a battery charger, so that the protective function cannot be used in the battery pack. Also, when the battery pack enters a deeply discharged state, charging of the battery pack is prohibited under control of a microcomputer. Hence, the protective function cannot be used if the microcomputer goes out of control.

According to the technique disclosed in Japanese Unexamined Patent Publication No. 2003-168490, the operation guaranteed voltage of the volatile memory is applied as a deep discharge detection level. Generally, the operation guaranteed voltage of a volatile memory is device-dependent, so that it is difficult to change the operation guaranteed voltage of the volatile memory. Therefore, when the type of the battery is changed or relevant safety requirements are changed making it necessary to change the voltage level used as a criterion for determining a deep discharge state of the battery, it unavoidably becomes necessary to substantially change the circuit configuration. Also, since an external device coupled to the battery pack is used to detect a change in the information stored in the volatile memory, the detection processing cannot be completed within the battery pack.

Other objects and novel features of the present invention will become clear from the following description and attached drawings.

A typical means of solving problems according to the present invention is outlined below.

A semiconductor device for battery control is provided with a control circuit capable of controlling turning on/off of a charging transistor coupled in series to a battery, a CPU capable of controlling, via the control circuit, charging of the battery, and a deep discharge detection circuit capable of detecting a deeply discharged state of the battery based on a reference voltage set as a threshold for detecting a deep discharge of the battery. The semiconductor device for battery control is also provided with a switch circuit which, when a deeply discharged state of the battery is detected by the deep discharge detection circuit, preferentially sends the result of the detection made by the deep discharge detection circuit to the control circuit and, thereby, forcibly turns off the charging transistor regardless of charging control by the CPU.

The effects realized by the typical means of solving problems according to the present invention are summarized below.

A deeply discharged state of a battery can be detected and charging of the battery can be prohibited without CPU involvement. Moreover, even in cases in which the type of the battery is changed or relevant safety requirements are changed making it necessary to change the voltage level used as a criterion for determining a deep discharge state of the battery, it does not become necessary to substantially change the circuit configuration.

### BRIEF DESCRIPTION OF THE DRAWINGS

FIG. 1 is a block diagram showing an example of configuration of a battery pack.

FIG. 2 is a circuit diagram showing an example of configuration of the switch circuit and the FET control circuit included in the battery pack shown in FIG. 1.

FIG. 3 is a more detailed circuit diagram showing an example of configuration of the switch circuit and the FET control circuit included in the battery pack shown in FIG. 1.

FIG. 4 illustrates a main operation performed in the battery pack shown in FIG. 1.

FIG. 5 illustrates a main operation performed in the battery pack shown in FIG. 1.

FIG. 6 illustrates a main operation performed in the battery pack shown in FIG. 1.

FIG. 7 is a circuit diagram showing an example of configuration of the overvoltage/overcurrent detection circuit included in the battery pack shown in FIG. 1.

FIG. 8 is a circuit diagram showing an example of configuration of the deep discharge detection circuit included in the battery pack shown in FIG. 1.

### DETAILED DESCRIPTION

### 1. Outline of Embodiments

First, typical embodiments of the invention disclosed in the present application will be outlined. Note that the reference numerals used in attached drawings and referred to, in parentheses, in the following outline description of typical embodiments of the present invention merely denote exemplary constituent elements included in the concepts of possible constituent elements.

[1] A semiconductor device for battery control according to a typical embodiment includes a control circuit (110) capable of controlling turning on/off of a charging transistor (13) coupled in series to a battery, a CPU (102) capable of controlling, via the control circuit, charging of the battery, and a deep discharge detection circuit (109) capable of detecting a deeply discharged state of the battery based on a reference voltage set as a threshold for detecting a deep discharge of the battery. The semiconductor device for battery control also includes a switch circuit (111) which, when a deeply discharged state of the battery is detected by the deep discharge detection circuit, preferentially sends the result of the detection made by the deep discharge detection circuit to the control circuit and, thereby, forcibly turns off the charging transistor regardless of charging control by the CPU.

According to the above configuration, when a deeply discharged state of the battery is detected by the deep discharge detection circuit, the switch circuit preferentially sends the result of the detection made by the deep discharge detection circuit to the control circuit and, thereby, forcibly turns off the charging transistor regardless of charging control by the CPU. In this way, the charging path for the battery can be shut off without involving the CPU and subsequent charging of the battery can be prohibited. Also, when a reference voltage level for determining a deeply discharged state of the battery is changed corresponding to a change in the type of the battery or a change in relevant safety requirements, the reference voltage level set as a threshold for determining a deep discharge of the battery can be changed without substantially changing the circuit configuration.

[2] In the configuration described in [1] above, the deep discharge detection circuit can be configured so as to assert a deep discharge detection signal at a low level by detecting a deeply discharged state of the battery. The switch circuit can be easily configured to include a first switch element (SW1) which is turned on/off according to the deep discharge detection signal and a second switch element (SW2) which is turned on/off complementarily with the first switch element according to the deep discharge detection signal. The first switch element (SW1) is turned on in a state with the deep discharge detection signal negated at a high level by the deep discharge detection circuit and sends the control signal from the CPU to the control circuit. The second switch element (SW2) is turned on in a state with the deep discharge detection signal asserted by the deep discharge detection circuit and sends the deep discharge detection signal from the deep discharge detection circuit to the control circuit. The first switch element and the second switch element may each be comprised of a MOS transistor.

[3] In the configuration described in [2] above, the control circuit can be configured to include logic gates (302, 303) for sending the control signal received via the first switch element or the deep discharge detection signal received via the second switch element to the control terminal of the charging transistor and a resistor (301) for pulling up/down the control terminal (gate electrode) of the charging transistor to a high/low level. The resistor pulling up/down the control terminal of the charging transistor stabilizes the logic state and the operation of the charging transistor.

[4] In the configuration described in [3] above, the resistor can be provided to cause the deep discharge detection signal to be supplied to the control terminal of the charging transistor. The control terminal of the charging transistor is then pulled up/down by the deep discharge detection signal, so that the operation of the charging transistor is stabilized. For example, in cases where the charging transistor (13) is an n-channel MOS transistor (13), when the deep discharge detection signal is negated at a high level, the control terminal (gate electrode) of the charging MOS transistor is pulled up to a high level via the resistor thereby making it easy for the charging MOS transistor to be stable in an on state and, when the deep discharge detection signal is asserted at a low level, the control terminal (gate electrode) of the charging MOS transistor is pulled down to a low level via the resistor thereby making it easy for the charging MOS transistor to be stable in an off state.

[5] In the configuration described in [3] above, the resistor can be provided to pull down the control terminal of the charging transistor to a low level. With the control terminal of the charging transistor pulled down to a low level, even if the CPU goes out of control, the charging MOS transistor stays stable in an off state and the battery is kept secure.

[6] Another semiconductor device for battery control according to a typical embodiment can be configured to include a charging transistor (13) coupled in series to a battery. The semiconductor device for battery control can be provided with a control circuit (110) capable of controlling turning on/off of the charging transistor, a CPU (102) capable of controlling, via the control circuit, charging of the battery, and a deep discharge detection circuit (109) capable of detecting a deeply discharged state of the battery based on a reference voltage set as a threshold for detecting a deep discharge of the battery. The semiconductor device for battery control can also be provided with a switch circuit (111) which, when a deeply discharged state of the battery is detected by the deep discharge detection circuit, preferentially sends the result of the detection made by the deep discharge detection circuit to the control circuit and, thereby, forcibly turns off the charging transistor regardless of charging control by the CPU.

As described above, the semiconductor device for battery control can be configured to include the charging transistor while also achieving the effects described in [1] to [5] above.

[7] A battery pack (1) according to a typical embodiment includes a chargeable battery (11) and a semiconductor device for battery control which can control charging of the battery. The semiconductor device for battery control includes a charging transistor (13) coupled in series to the battery, a control circuit (110) capable of controlling turning on/off of the charging transistor, a CPU (102) capable of controlling, via the control circuit, charging of the battery, and a deep discharge detection circuit (109) capable of detecting a deeply discharged state of the battery based on a reference voltage set as a threshold for detecting a deep discharge of the battery. The semiconductor device for battery control also includes a switch circuit (111) which, when a deeply discharged state of the battery is detected by the deep discharge detection circuit, preferentially sends the result of the detection made by the deep discharge detection circuit to the control circuit and, thereby, forcibly turns off the charging transistor regardless of charging control by the CPU.

According to the above configurations, the effects described in [1] to [5] above are achieved completely inside the battery pack without requiring any external device or circuit. Namely, no external dependence is involved.

### 2. Details of Embodiments

The embodiments will be described in further detail below.

### First Embodiment

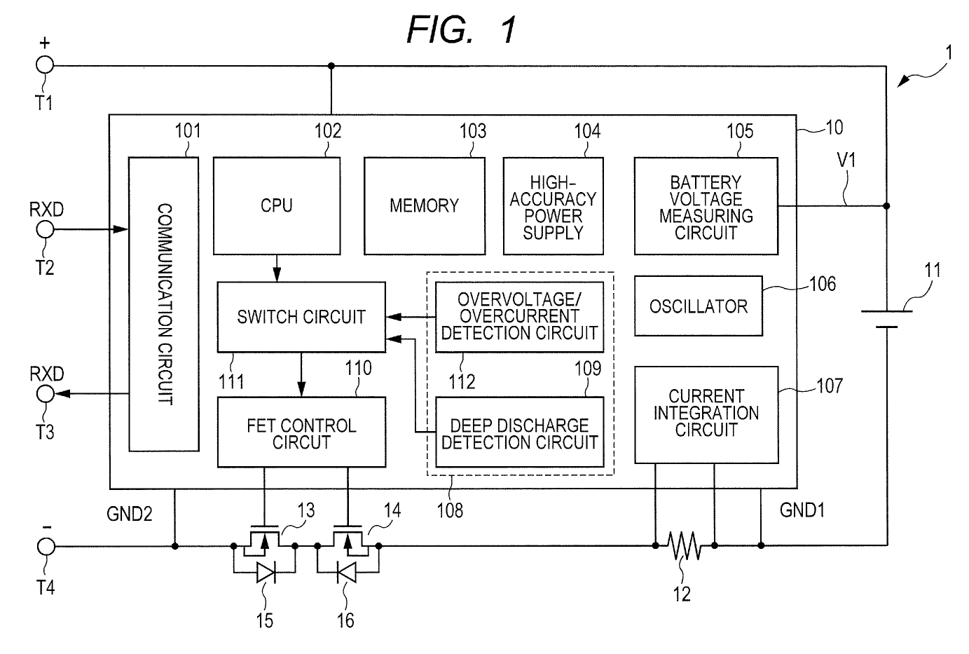

FIG. 1 shows an example of a battery pack configuration.

A battery pack 1 shown in FIG. 1 includes a battery 11, an IC (Integrated Circuit) 10 for battery control which controls charging/discharging of the battery 11, a sense resistor 12, a charging MOS transistor 13, and a discharging MOS transistor 14. The battery pack 1 is sealed by, for example, insulating resin. The charging MOS transistor 13 and the discharging MOS transistor 14 may each be, though not limited to, an n-channel MOS transistor. The battery pack 1 is provided with terminals T1, T2, T3, and T4. The terminal T1 is a positive (+) terminal. The terminal T4 is a negative (−) terminal. The terminal T2 is for data reception. The terminal T3 is for data transmission. The terminals T1, T2, T3, and T4 of the battery pack 1 are coupled to a battery charger, not shown, which charges the battery pack 1. The battery pack 1 that has been charged is installed, for example, in a mobile terminal or a digital camera and functions as a power supply for operating the electronic circuit of the mobile terminal or digital camera.

While not limited thereto, the IC 10 for battery control is formed on a semiconductor substrate of, for example, monocrystal silicon using a known semiconductor integrated circuit fabrication technique. The battery 11 is a lithium-ion secondary battery. Charging of the battery 11 is controlled by the IC 10 for battery control. The IC 10 for battery control is externally attached with the charging MOS transistor 13, the discharging MOS transistor 14, and the sense resistor 12. The charging MOS transistor 13, the discharging MOS transistor 14, and the sense resistor 12 are coupled in series to the battery 11. Turning on and off of the charging MOS transistor 13 and the discharging MOS transistor 14 is controlled by the IC 10 for battery control. The path between the battery 11 and the sense resistor 12 is at a potential of a first ground GND1. The path between the discharging MOS transistor 14 and the terminal T4 is at a potential of a second ground GND2.

While not limited thereto, the IC 10 for battery control includes a communication circuit 101, a CPU 102, a memory 103, a high-accuracy power supply 104, a battery voltage measuring circuit 105, an oscillator 106, a current integration circuit 107, a protective function circuit 108, an FET control circuit 110, and a switch circuit 111.

The communication circuit 101 exchanges battery pack 1 identification data and control data for charging/discharging of the battery pack 1 with a battery charger or a mobile terminal coupled thereto.

The CPU 102 controls charging of the battery pack 1 in accordance with a preset program.

The memory 103 includes a ROM (Read Only Memory) and a RAM (Random Access Memory). The ROM stores programs to be executed by the CPU 102. The RAM is used, for example, as a work area when the programs are executed.

The high-accuracy power supply 104 generates constant voltages of various levels based on the voltage inputted from outside to the IC 10 for battery control. The constant voltages thus generated are supplied as voltages having relatively high stability to various parts. Such voltages include, for example, voltages supplied to resistors used for voltage dividing and reference voltages supplied to comparator circuits.

The battery voltage measuring circuit 105 measures a positive voltage V1 of the battery 11 based on the first ground GND1 as a reference. The result of the voltage measurement is converted into a digital signal and is sent to the CPU 102.

The oscillator 106 generates a clock signal for logic circuit operation in the IC 10 for battery control. The clock signal is supplied to various parts of the IC 10 for battery control.

The current integration circuit 107 measures the charging/discharging current of the battery 11 by monitoring the voltage across both ends of the sense resistor 12. The result of the current measurement is converted into a digital signal and is sent to the CPU 102.

The protective function circuit 108 is provided to prevent the battery 11 from being damaged by an overvoltage, overcurrent or deep discharge of the battery pack 1. The protective function circuit 108 includes an overvoltage/overcurrent detection circuit 112 and a deep discharge detection circuit 109. The overvoltage/overcurrent detection circuit detects an overvoltage state and an overcurrent state. The deep discharge detection circuit 109 detects a deeply discharged state of the battery 11. The results of overvoltage or overcurrent detection at the overvoltage/overcurrent detection circuit 112 and deep-discharge detection at the deep discharge detection circuit 109 are sent to the FET control circuit 110.

The FET control circuit 110 controls turning on/off of the charging MOS transistor 13 based on the control signal from the CPU 102 and the results of detection by the overvoltage/overcurrent detection circuit 112 and the deep discharge detection circuit 109. The FET control circuit 110 also controls turning on/off of the discharging MOS transistor 14 based on the control signal from the CPU 102 and the result of detection by the overvoltage/overcurrent detection circuit 112. The charging MOS transistor 13 is turned on when charging the battery 11 and is turned off when the battery 11 has risen to a predetermined voltage level.

In a state where the charging MOS transistor 13 is off, the battery 11 cannot be charged but can be discharged via a parasitic diode 15 coupled in parallel to the charging MOS transistor 13. When an overvoltage is detected by the overvoltage/overcurrent detection circuit 112 while the battery 11 is being charged, the FET control circuit 110 turns off the charging MOS transistor 13. As result, charging of the battery 11 is discontinued.

When the voltage of the battery 11 lowers to a predetermined level, the FET control circuit 110 turns off the discharging MOS transistor 14. This blocks the discharging current from the battery 11. In a state where the discharging MOS transistor 14 is off, the battery 11 cannot be discharged, but can be charged via a parasitic diode 16 coupled in parallel to the discharging MOS transistor 14. When an overcurrent is detected by the overcurrent detection circuit 112 while the battery 11 is being discharged, the FET control circuit 110 turns off the discharging MOS transistor 14, thereby blocking the overcurrent.

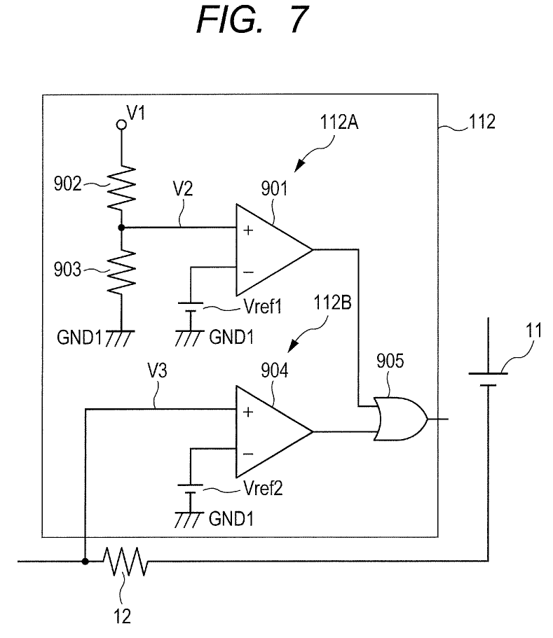

The overvoltage/overcurrent detection circuit 112 includes, for example, as shown in FIG. 7, an overvoltage detection circuit 112A for overvoltage detection and an overcurrent detection circuit 112B for overcurrent detection. The overvoltage detection circuit 112A includes resistors 902 and 903 coupled in series for dividing the positive voltage V1 of the battery 11 and a comparator 901. The resistor 902 is applied with the positive voltage V1 of the battery 11. The resistor 903 is coupled to the first ground GND1. The comparator 901 compares the potential V2 of the node between the series-coupled resistors 902 and 903 and a reference voltage Vref1 and outputs the comparison result as an overvoltage detection result (an overvoltage detection signal). The overcurrent detection circuit 112B includes a comparator 904. The comparator 904 compares a terminal voltage V3 of the sense resistor 12 based on the first ground GND1 and a reference voltage Vref2 and outputs the comparison result as an overcurrent detection result (an overcurrent detection signal). The outputs of the comparators 901 and 904 are ORed by an OR gate 905, and the output of the OR gate 905 is applied as an overvoltage/overcurrent detection signal. The reference voltages Vref1 and Vref2 are generated by the high-accuracy power supply 104.

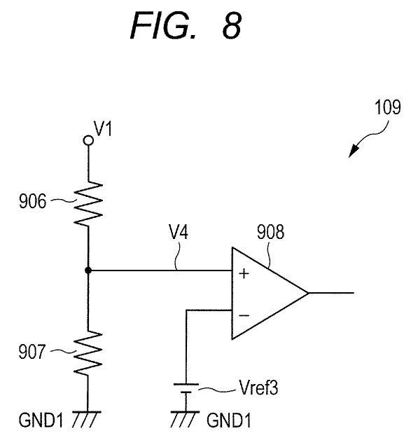

The deep discharge detection circuit 109 includes, for example, as shown in FIG. 8, resistors 906 and 907 coupled in series to divide the positive voltage V1 of the battery 11 and a comparator 908. The resistor 906 is applied with the positive voltage V1 of the battery 11. The resistor 907 is coupled to the first ground GND1. The comparator 908 compares the potential V4 of the node between the series-coupled resistors 906 and 907 and a reference voltage Vref3 and outputs the comparison result as an overvoltage detection result (the overvoltage detection signal). The reference voltage Vref3 is used as a threshold for detecting a deeply discharged state of the battery 11. The reference voltage Vref3 is generated, for example, by voltage division carried out at the high-accuracy power supply 104 using plural series-coupled resistors (ladder resistor). The level of the reference voltage Vre3 can easily be changed by switching between the ladder resistor taps (series-coupling nodes).

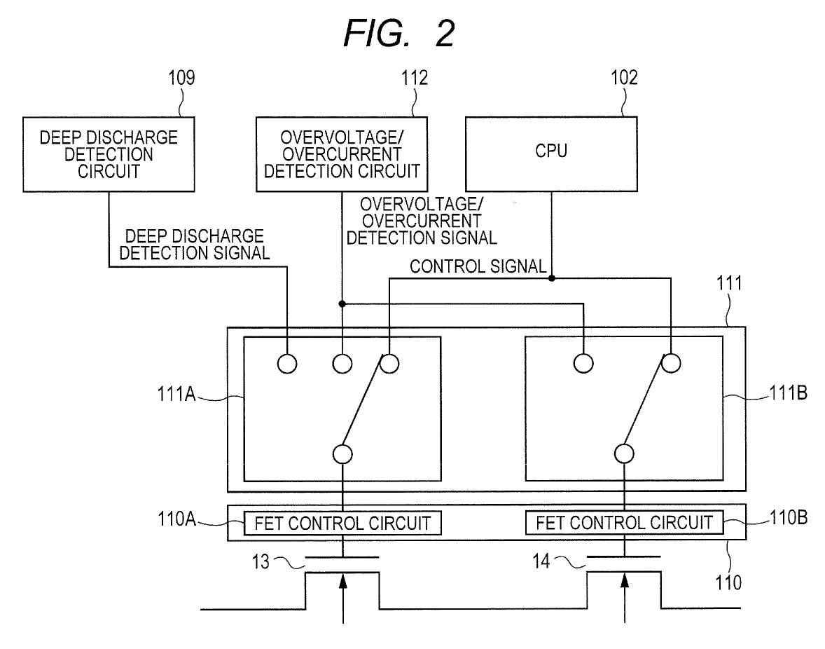

FIG. 2 shows an example of configuration of the switch circuit 111 and the FET control circuit 110.

The switch circuit 111 includes a first switch circuit 111A corresponding to the charging MOS transistor 13 and a second switch circuit 111B corresponding to the discharging MOS transistor 14. The first switch circuit 111A selectively transfers the deep discharge detection signal outputted from the deep discharge detection circuit 109, the overvoltage/overcurrent detection signal outputted from the overvoltage/overcurrent detection circuit 112, and a control signal outputted from the CPU 102 to the FET control circuit 110. The second switch circuit 111B selectively transfers the overvoltage/overcurrent detection signal outputted from the overvoltage/overcurrent detection circuit 112 and a control signal outputted from the CPU 102 to the FET control circuit 110. For this operation, the detection result at the deep discharge detection circuit 109 is treated as the highest priority detection result. Namely, when a deeply discharged state of the battery 11 is detected by the deep discharge detection circuit 109, the charging MOS transistor 13 is forcibly turned off regardless of charging control by the CPU 102 or the result of overvoltage and overcurrent detection at the overvoltage/overcurrent detection circuit 112.

The FET control circuit 110 includes a first FET control circuit 110A corresponding to the charging MOS transistor 13 and a second FET control circuit 110B corresponding to the discharging MOS transistor 14. The first FET control circuit 110A controls turning on/off of the charging MOS transistor 13 based on the signal received via the first switch circuit 111A. The second FET control circuit 110B controls turning on/off of the discharging MOS transistor 14 based on the signal received via the second switch circuit 111B.

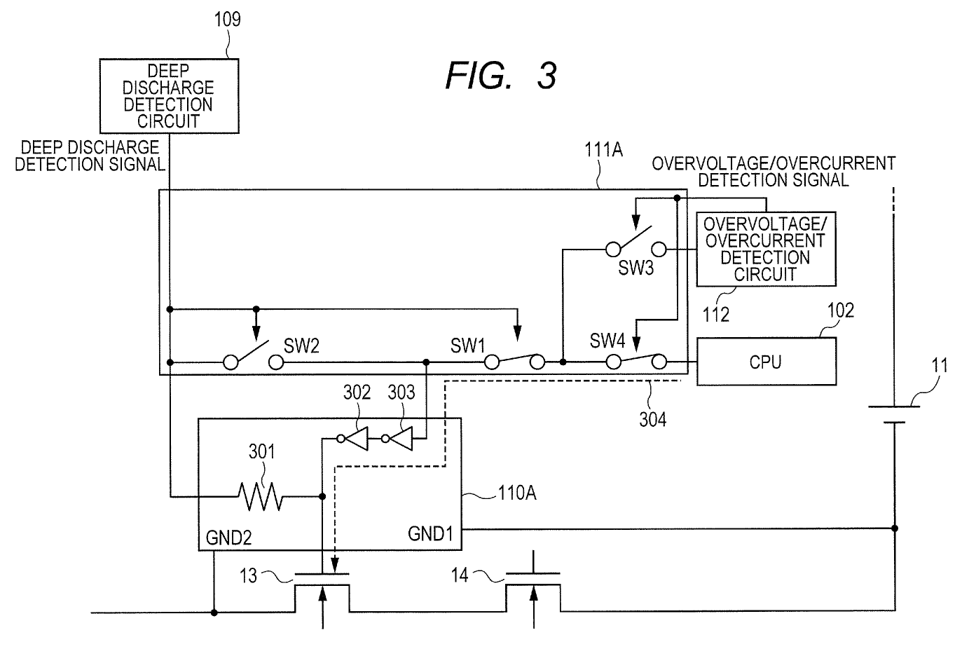

FIG. 3 shows an example of configuration of the first switch circuit 111A and the first FET control circuit 110A.

The first switch circuit 111A is comprised of four switch elements SW1, SW2, SW3, and SW4. The four switch elements SW1, SW2, SW3, and SW4 may each be a MOS transistor. The first switch element SW1 and the fourth switch elements SW4 are provided between the CPU 102 and the first FET control circuit 110A. When the first switch element SW1 and the fourth switch element SW4 are turned on, a path for transferring a control signal outputted from the CPU 102 to the first FET control circuit 110A is formed. The second switch element SW2 is provided between the deep discharge detection circuit 109 and the first FET control circuit 110A. When the second switch element SW2 is turned on, a path for transferring the deep discharge detection signal outputted from the deep discharge detection circuit 109 to the first FET control circuit 110A is formed. The third switch element SW3 is provided between the overvoltage/overcurrent detection circuit 112 and the first switch element SW1. When the first switch element SW1 and the third switch element SW3 are turned on, a path for transferring the overvoltage/overcurrent detection signal outputted from the overvoltage/overcurrent detection circuit 112 to the first FET control circuit 110A is formed. The first switch element SW1 and the second switch element SW2 are complementarily turned on and off according to the deep discharge detection signal outputted from the deep discharge detection circuit 109. For example, when the deep discharge detection signal outputted from the deep discharge detection circuit 109 is asserted (set low), the first switch element SW1 is turned off and the second switch element SW2 is turned on. When the deep discharge detection signal outputted from the deep discharge detection circuit 109 is negated (set high), the first switch element SW1 is turned on and the second switch element SW2 is turned off. The third switch element SW3 and the fourth switch element SW4 are complementarily turned on/off according to the overvoltage/overcurrent detection signal outputted from the overvoltage/overcurrent detection circuit 112. For example, when the overvoltage/overcurrent detection signal outputted from the overvoltage/overcurrent detection circuit 112 is asserted (set low), the third switch element SW3 is turned on and the fourth switch element SW4 is turned off. When the overvoltage/overcurrent detection signal outputted from the overvoltage/overcurrent detection circuit 112 is negated (set high), the third switch element SW3 is turned off and the fourth switch element SW4 is turned on.

The first FET control circuit 110A includes series-coupled inverters 302 and 303. The signal transferred via the second switch element SW2 or the third switch element SW3 is sent to the gate (control terminal) of the charging MOS transistor 13 via the inverters 302 and 303. One end of the resistor 301 is coupled to the gate of the charging MOS transistor 13. The other end of the resistor 301 is applied with the deep discharge detection signal outputted from the deep discharge detection circuit 109.

The operation of the above configuration will be described in the following.

When charging the battery pack 1, the terminals T1, T2, T3, and T4 are coupled to a charger, not shown. In this state, the positive voltage V1 of the battery 11 is measured by the battery voltage measuring circuit 105 and the measurement result is sent to the CPU 102. When the positive voltage V1 of the battery 11 is in an operable voltage range, the first switch circuit 111A enters the state shown in FIG. 3. Namely, the deep discharge detection signal outputted from the deep discharge detection circuit 109 is set to a high level causing the first switch element SW1 to be turned on and the second switch element SW2 to be turned off. At this time, the resistor 301 causes the gate electrode of the charging MOS transistor 13 to be pulled up to the high level of the deep discharge detection signal. Also, when the overvoltage/overcurrent detection signal outputted from the overvoltage/overcurrent detection circuit 112 is set to a high level, the third switch element SW3 is turned off and the fourth switch element SW4 is turned on. In this state, the control signal outputted from the CPU 102 is sent to the first FET control circuit 110A via the first switch element SW1 and the fourth switch element SW4 as indicated by a broken-line arrow 304 in FIG. 3. Thus, the state of the charging MOS transistor 13 is dependent on the control by the CPU 102. When the control signal outputted from the CPU 102 is set to a low level causing the charging MOS transistor 13 to be turned on, a charging current is made to flow through the battery 11 for charging. Eventually, when the positive voltage V1 of the battery 11 reaches a predetermined level, the control signal outputted from the CPU 102 goes high and the charging MOS transistor 13 is turned off to terminate charging.

When the voltage of the battery 11 lowers to a level which is not so low as a deep discharge voltage but which is low enough to make the CPU 102 inoperable, with the gate electrode of the charging MOS transistor 13 pulled up by the resistor 301, the charging MOS transistor 13 is turned on making it possible to charge the battery 11.

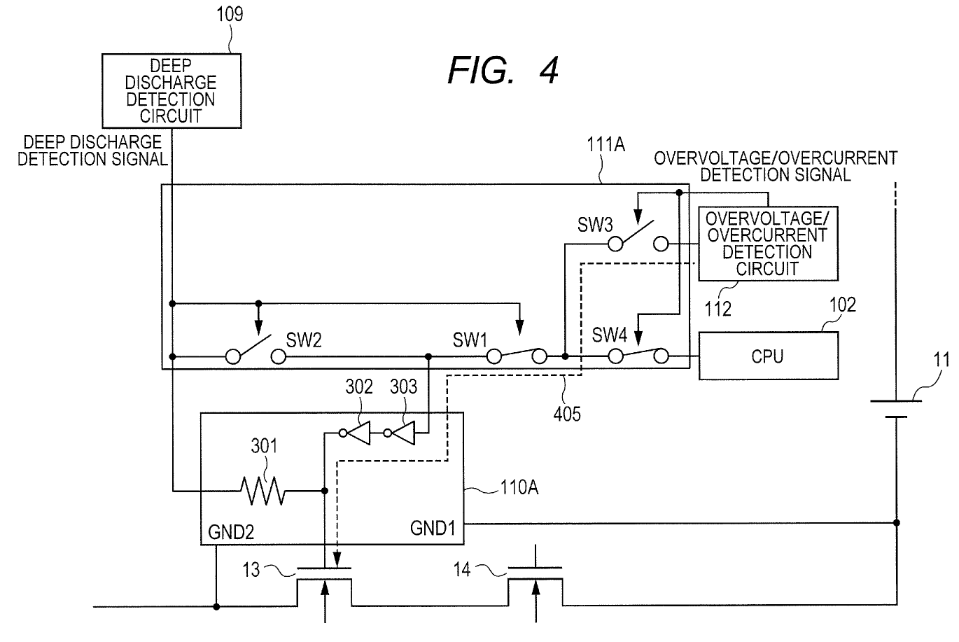

When, during charging of the battery 11, the overvoltage/overcurrent detection circuit 112 detects an overvoltage or overcurrent, the overvoltage/overcurrent detection signal outputted from the overvoltage/overcurrent detection circuit 112 goes low, causing the third switch element SW3 to be turned on and the fourth switch element SW4 to be turned off as shown in FIG. 4. This causes the overvoltage/overcurrent detection signal of a low level outputted from the overvoltage/overcurrent detection circuit 112 to be sent to the first FET control circuit 110A via the switches SW1 and SW3 as indicated by a broken-line arrow 405 in FIG. 4. As a result, the charging MOS transistor 13 is turned off and charging of the battery 11 is discontinued.

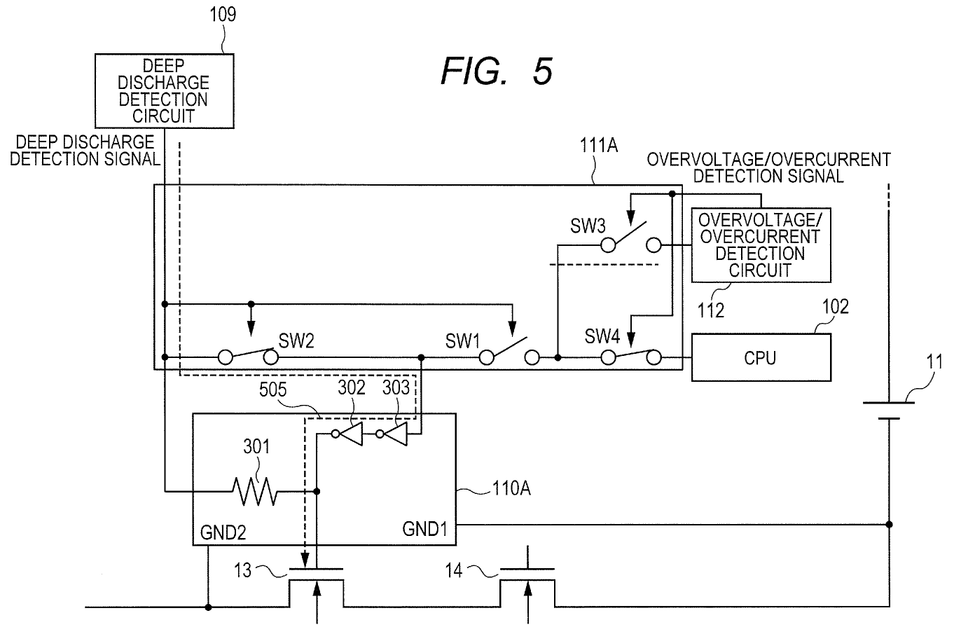

When a deeply discharged state of the battery 11 is detected by the deep discharge detection circuit 109, the deep discharge detection signal is set to a low level causing the first switch element SW1 to be turned off and the second switch element SW2 to be turned on as shown in FIG. 5. When the deep discharge detection signal is set to a low level, the gate of the charging MOS transistor 13 is pulled down to the level of the second ground GND2 via the resistor 301. In this state, the deep discharge detection signal of a low level is, as indicated by a broken-line arrow 505, sent to the first FET control circuit 110A via the second switch element SW2 causing the charging MOS transistor 13 to be turned off. At this time, with the first switch element SW1 turned off, the control signal from the CPU 102 and the overvoltage/overcurrent detection signal from the overvoltage/overcurrent detection circuit 112 are not sent to the first FET control circuit 110A. Namely, when a deeply discharged state of the battery 11 is detected and the deep discharge detection signal is set to a low level, the charging MOS transistor 13 is forcibly turned off regardless of control by the overvoltage/overcurrent detection circuit 112 and the CPU 102. As a result, charging of the battery 11 is prohibited.

According to the first embodiment, the following effects can be obtained.

(1) The deep discharge detection circuit 109 determines a deep discharge voltage threshold based on the reference voltage Vref3 as shown in FIG. 8, and the level of the reference voltage Vref3 can be easily changed by switching the ladder resistor tapping point in the high-accuracy power supply 104. Therefore, the threshold setting for deep discharge detection can be easily changed. An effect of this is that, even when a reference voltage level for determining a deeply discharged state of the battery 11 is changed corresponding to a change in the type of the battery 11 or a change in relevant safety requirements, the reference voltage level can be easily changed without substantially changing the circuit configuration.

(2) The first switch element SW1 and the second switch element SW2 are complementarily turned on/off by the deep discharge detection signal outputted from the deep discharge detection circuit 109. Namely, as shown in FIG. 5, when the deep discharge detection signal is set to a low level and the second switch element SW2 is turned on, the first switch element SW1 is turned off. This prevents the deep discharge detection signal outputted from the deep discharge detection circuit 109 from colliding with the control signal from the CPU 102 or with the overvoltage/overcurrent detection signal from the overvoltage/overcurrent detection circuit 112. Hence, even if the CPU 102 goes out of control, the deep discharge detection signal is not affected.

(3) When the battery 11 is neither in a deeply discharged state nor in an overvoltage/overcurrent state during charging, the charging MOS transistor 13 is dependent on the control by the CPU 102. Even if the control by the CPU 102 becomes unstable, however, the electrode of the charging MOS transistor 13 is stabilized by being pulled up or down via the resistor 301. Namely, when the deep discharge detection signal is at a high level, the gate electrode of the charging MOS transistor 13 is pulled up to a high level via the resistor 301, making it easier for the charging MOS transistor 13 to be stable in an on state. When the deep discharge detection signal is at a low level, the gate electrode of the charging MOS transistor 13 is pulled down to a low level via the resistor 301, making it easier for the charging MOS transistor 13 to be stable in an off state.

(4) Since the off state of the charging MOS transistor 13 is a stable deeply discharged state, after a deeply discharged state is reached, a charging-prohibited state can be maintained.

(5) According to the first embodiment, the above effects (1) to (4) are achieved completely within the battery pack 1, so that no external device or circuit is required for deep discharge detection. Namely, no external dependence is involved.

### Second Embodiment

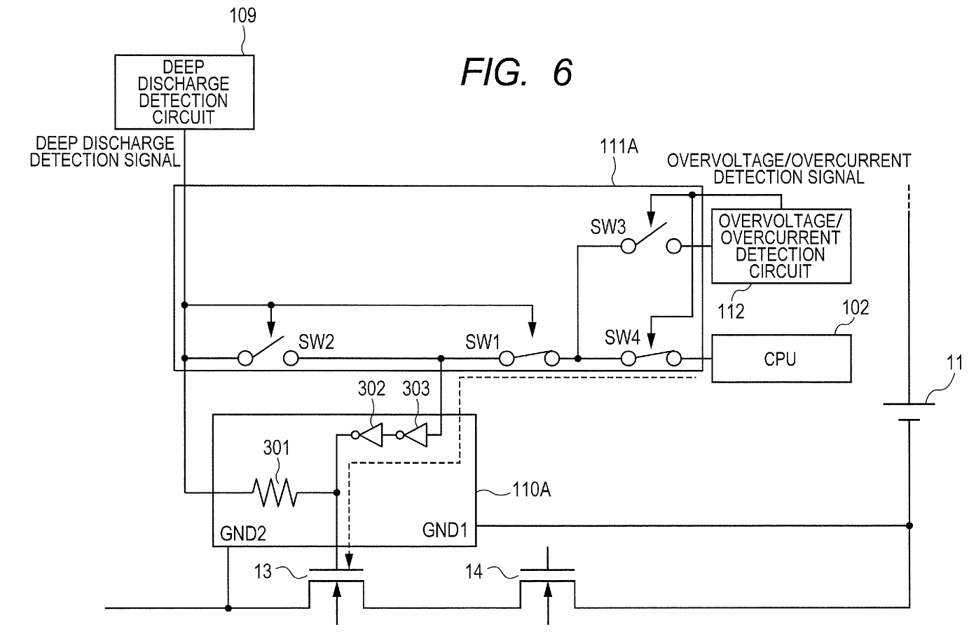

FIG. 6 shows another exemplary configuration of the first FET control circuit 110A.

The configuration shown in FIG. 6 differs from the configuration shown in FIG. 3 in that the resistor 301 is pulled down to the second ground GND2 (the source electrode of the charging MOS transistor 13). The basic operation of the circuit shown in FIG. 6 including the four switch elements SW1, SW2, SW3, and SW4 is the same as the basic operation in the first embodiment.

When the battery 11 is neither in a deeply discharged state nor in an overvoltage/overcurrent state, the first switch element SW1 is on, so that control by the CPU 102 or by the overvoltage/overcurrent detection circuit 112 is effective. With the gate electrode of the charging MOS transistor 13 pulled down, the logic level of the gate electrode of the charging MOS transistor 13 can be controlled by the CPU 102 or by the overvoltage/overcurrent detection circuit 112 even when the gate electrode of the charging MOS transistor 13 is at a low level. Also, when a deeply discharged state of the battery 11 is detected by the deep discharge detection circuit 109, the deep discharge detection signal can be sent to the first FET control circuit 110A by turning on the second switch element SW2 as in the first embodiment, so that charging of the battery 11 can be prohibited by turning the charging MOS transistor 13 off. Thus, in the second embodiment, too, the effects like those of the first embodiment can be obtained.

Furthermore, in the second embodiment, the charging MOS transistor 13 is kept pulled down to the second ground GND2 (the source electrode of the charging MOS transistor 13) via the resistor 301. Therefore, even if the CPU 102 goes out of control, the charging MOS transistor 13 stays stable in an off state and the battery 11 is kept secure.

The invention made by the present inventors has been concretely described based on embodiments, but, obviously, the invention is not limited to the embodiments and can be variously changed without departing from the scope of the invention.

What is claimed is:

1. A semiconductor device for battery control comprising:
a control circuit capable of controlling turning on/off of a charging transistor coupled in series to a battery;
a CPU capable of controlling, via the control circuit, charging of the battery;
a deep discharge detection circuit capable of detecting a deeply discharged state of the battery based on a reference voltage set as a threshold for detecting a deep discharge of the battery; and
a switch circuit which, when a deeply discharged state of the battery is detected by the deep discharge detection circuit, preferentially sends the result of the detection made by the deep discharge detection circuit to the control circuit and, thereby, forcibly turns off the charging transistor regardless of charging control by the CPU.

2. The semiconductor device for battery control according to claim 1,
wherein the deep discharge detection circuit is configured to assert a deep discharge detection signal by detecting a deeply discharged state of the battery;
wherein the switch circuit includes a first switch element which is turned on/off according to the deep discharge detection signal and a second switch element which is turned on/off according to the deep discharge detection signal complementarily with the first switch element;
wherein the first switch element is turned on in a state with the deep discharge detection signal negated by the deep discharge detection circuit and sends a control signal from the CPU to the control circuit, and
wherein the second switch element is turned on in a state with the deep discharge detection signal asserted by the deep discharge detection circuit and sends the deep discharge detection signal from the deep discharge detection circuit to the control circuit.

3. The semiconductor device for battery control according to claim 2,
wherein the control circuit includes;
a logic gate for sending the control signal received via the first switch element or the deep discharge detection signal received via the second switch element to a control terminal of the charging transistor, and
a resistor for pulling up or down the control terminal of the charging transistor.

4. The semiconductor device for battery control according to claim 3,
wherein the resistor is provided to cause the deep discharge detection signal to be supplied to the control terminal of the charging transistor, and
wherein the control terminal of the charging transistor is pulled up or down by the deep discharge detection signal.

5. The semiconductor device for battery control according to claim 3, wherein the resistor is provided to pull down the control terminal of the charging transistor.

6. A semiconductor device for battery control comprising:
a charging transistor coupled in series to a battery;
a control circuit capable of controlling turning on/off of the charging transistor;
a CPU capable of controlling, via the control circuit, charging of the battery;
a deep discharge detection circuit capable of detecting a deeply discharged state of the battery based on a reference voltage set as a threshold for detecting a deep discharge of the battery, and
a switch circuit which, when a deeply discharged state of the battery is detected by the deep discharge detection circuit, preferentially sends the result of the detection made by the deep discharge detection circuit to the control circuit and, thereby, forcibly turns off the charging transistor regardless of charging control by the CPU.

7. A battery pack having a chargeable battery and a semiconductor device for battery control which can control charging of the battery, the semiconductor device for battery control comprising:
a charging transistor coupled in series to the battery;
a control circuit capable of controlling turning on/off of the charging transistor;
a CPU capable of controlling, via the control circuit, charging of the battery;
a deep discharge detection circuit capable of detecting a deeply discharged state of the battery based on a reference voltage set as a threshold for detecting a deep discharge of the battery, and
a switch circuit which, when a deeply discharged state of the battery is detected by the deep discharge detection circuit, preferentially sends the result of the detection made by the deep discharge detection circuit to the control circuit and, thereby, forcibly turns off the charging transistor regardless of charging control by the CPU.
